(19) United States
(12) Patent Application Publication
(10) Pub. No.: US 2009/0241111 A1
(43) Pub. Date: Sep. 24, 2009

(54) RECORDING MEDIUM HAVING INSTRUCTION LOG ACQUIRING PROGRAM RECORDED THEREIN AND VIRTUAL COMPUTER SYSTEM

(75) Inventor: Kenichirou Shimogawa, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/406,421

(22) Filed: Mar. 18, 2009

(30) Foreign Application Priority Data
Mar. 19, 2008 (JP) 2008-070544

(51) Int. Cl. G06F 9/455

(52) U.S. Cl. 718/1

(57) ABSTRACT

A computer-readable medium on which is recorded a program for causing an information processing device to execute, a holding process, in a judgment information holder, judgment information indicating an instruction from which log information may be acquired; a acquiring process for instructions of instruction addresses in a range determined on the basis of the instruction addresses of instructions which were finally executed by a plurality of virtual computers when control rights of a plurality of real CPUs is returned from the virtual computers to the virtual computer monitor; a judging process for whether the acquired instruction is an instruction indicated by the held judgment information; and a recording process, in a log information holder, log information containing the instruction address of an acquired instruction and a acquiring frequency at which the instruction concerned is acquired in the acquiring step when the acquired instruction is judged as the indicated instruction.

### CROSS-REFERENCE TO RELATED APPLICATION

This application is based upon and claims the benefit of priority of the prior Japanese Patent Application No. 2008-70544, filed on Mar. 19, 2008 the entire contents of which are incorporated herein by reference.

### FIELD

An aspect of the present invention relates to an instruction (command) log acquiring program and a virtual computer system.

### BACKGROUND

For example, in symmetric multi processing (SMP: Symmetric Multi Processing), a plurality of real CPUs (multi CPUs) have resources in common. That is, an OS kernel operating in SMP and general programs operating on the OS kernel execute target processing while successively executing operations in the multi CPU one by one (serializing). Each multi CPU of SMP acquires a lock word in a memory which can be referred to and renewed from each multi CPU of SMP, thereby implementing the serialization processing.

According to Japanese Laid-open Patent Publication No. 2005-527876, the technology which records the count value which records the demand about Locke by a thread and discloses the number of the threads which compete is proposed.

FIG. 9 is a diagram depicting an example of the serialization processing as a background of the present invention. Particularly, FIG. 9A depicts writing of a control right into a lock word, and FIG. 9B depicts the serialization processing using the lock word.

In FIG. 9B, for example, CPU #0 refers to a lock word (area) on a memory (step S100), and investigates whether the lock word is empty or not (step S101). If the lock word is not empty, the processing of step S100 and subsequent steps is repeated. If the lock word is empty, CPU #0 writes the control right into the lock word by executing a memory compare & store instruction (step S102). The memory compare & store instruction is the processing in which the compare and the writing of data are inseparably executed by one instruction. Thereafter, CPU #0 executes processing targeting the serialization (step S103). The processing targeting serialization (to be serialized) is the processing of accessing the same resource in terms of applications, for example, the processing such as renewal of a data base or the like, for example. After the processing targeting serialization is finished, CPU #0 clears the control right which was previously written in the lock word, thereby releasing the lock state (exclusive state) (step S104). That is, serialization is released.

As described above, each multi CPU successively executes the operation (processing) one by one so as to prevent the processing from being simultaneously executed by another CPU by writing the control right into the lock word. That is, serialization is performed. For example, when CPU #0 writes the control right into the lock word first, CPU #1 is set to a standby state until release of the lock (hereinafter referred to “lock standby state”). Accordingly, CPU #1 cannot write the control right into the lock word and cannot execute the processing until CPU #0 releases the control right of the lock word.

However, according to studies of the inventor, the serialization processing depicted in FIGS. 9A and 9B has the following problem.

When a CPU (for example, CPU #0) acquires serialization for a long time, long-term lock standby (or standby for serialization) occurs in other CPUs (for example, CPU #1) and the processing performance of the virtual computer system is deteriorated as a whole. Particularly, if it takes a long time to execute the processing targeting serialization of the step S103, overhead occurs due to the lock standby of the other CPUs, so that the processing performance of the virtual computer system is deteriorated as a whole.

Furthermore, when a general program operating on an OS kernel system-calls the OS kernel, serialization processing which is not estimated at the stage of design may start. In this case, a long time is required for the system call, and thus the processing performance of the virtual computer system is deteriorated as a whole. The general program operating on the OS kernel basically does not know how the OS kernel operates. Accordingly, the exclusive state of another CPU (for example, CPU #1) caused by the OS kernel executed on a CPU (for example, CPU #0) may occur due to the system call of a general program.

Furthermore, the problem that the processing performance of the virtual computer system is deteriorated due to the serialization processing is rarely detected at the state of the development of programs. This is because loads during tests are low at the development stage or the like. Therefore, in many cases, serialization processing is not detected until SMP is actually operated, and thus serialization processing has a great effect.

In order to deal with such a problem, it is necessary to perform program correction to enhance the performance of the virtual computer system. In order to perform the program correction, according to the study of the inventor, it would be convenient if a factor causing occurrence of the serialization processing can be detected to grasp the status of the lock release standby state caused by the serialization processing.

Furthermore, in addition to the serialization processing, an instruction inducing heavy (e.g., taking a long time) processing deteriorates the processing performance of the virtual computer system. Therefore, according to the study of the inventor, it would be convenient if processing which is different from the serialization processing and causes deterioration of the processing performance of the virtual computer system were detected.

### SUMMARY

According to an embodiment of the present invention, there is provided an instruction log acquiring program for implementing a virtual computer monitor in a virtual computer system equipped with a plurality of real CPUs and a plurality of virtual computers each of which comprises a program operating on the plurality of real CPUs, and the virtual computer monitor for controlling the plurality of virtual computers. This program makes a computer as the virtual computer system execute: a step of holding, in a judgment information holder, judgment information indicating an instruction from which log information should be acquired; a step of acquiring instructions of instruction addresses in a range determined based on the instruction addresses of instructions which were finally executed by the plurality of virtual computers when control rights of the plurality of real CPUs is returned from the plurality of virtual computers to the virtual computer monitor; a step of judging whether the acquired instruction is an instruction indicated by the held judgment information; and a step of recording, in a log information holder, log information containing the instruction address of an acquired instruction and an acquiring frequency at which the instruction concerned is acquired in the acquiring step when the acquired instruction is judged as the indicated instruction.

The object and advantages of the invention will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a diagram depicting an example of a virtual computer system;

FIG. 2 is a diagram depicting a construction of a virtual computer monitor according to an embodiment;

FIG. 3 is a diagram depicting an operation in real CPU in the virtual computer system;

FIG. 4 is a diagram depicting an example of a serialize-instruction judgment table;

FIG. 5 is a diagram depicting an example of serialization occurrence log data;

FIG. 6 is a diagram depicting an example of a report;

FIG. 7 is a log acquiring processing flow executed by a log acquiring processor;

FIG. 8 is a report processing flow executed by a report output unit; and

FIGS. 9A and 9B are diagrams depicting an example of serialization processing as a background of the present invention.

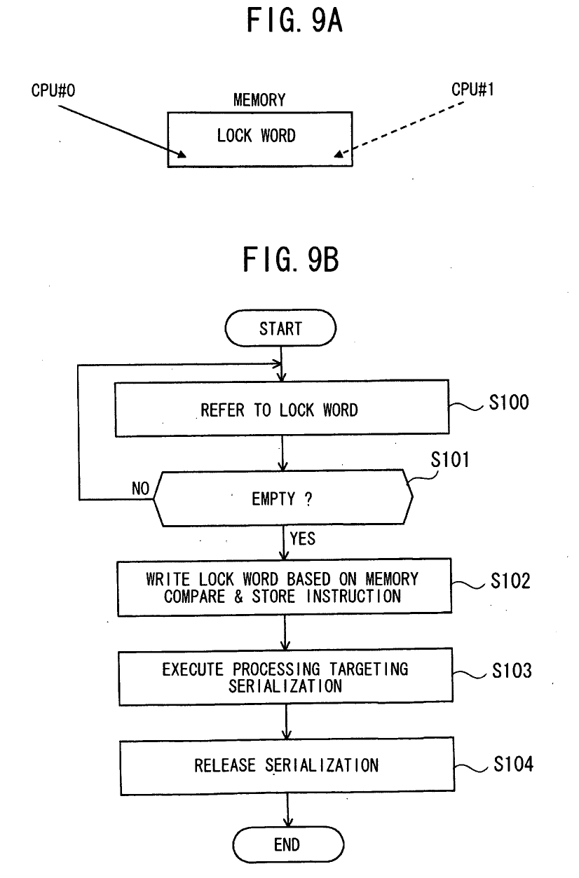

### DESCRIPTION OF EMBODIMENT

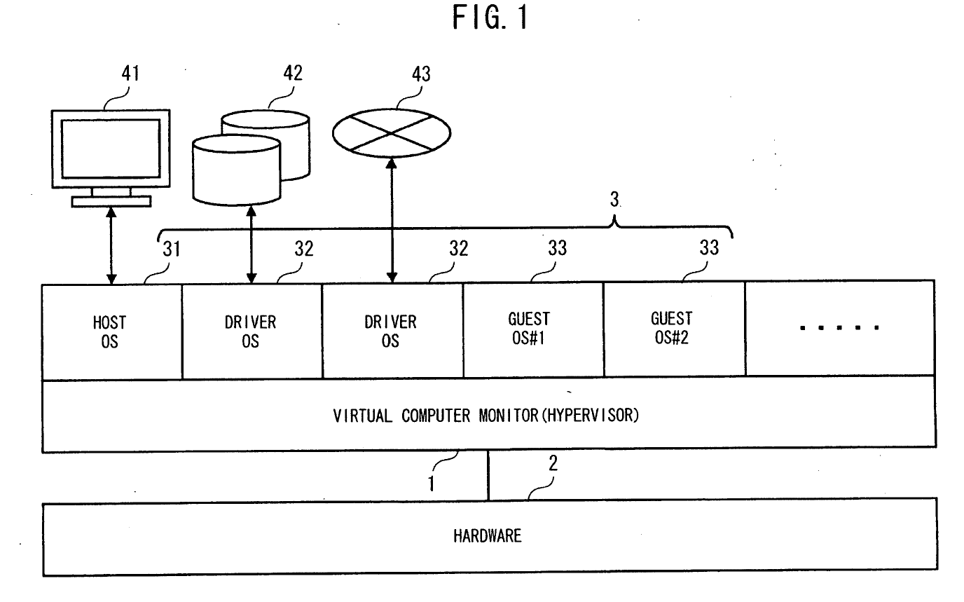

FIG. 1 is a diagram depicting the construction of a virtual computer system according to the present embodiment. The virtual computer system comprises a virtual computer monitor (VMM: Virtual Machine Monitor or Hypervisor) 1, hardware 2, and a plurality of virtual computers (VM: Virtual Machine) 3. The virtual computer monitor 1 and the virtual computer 3 operate on the hardware 2. Although not shown, the hardware 2 is equipped with a plurality of real CPUs (physical CPUs).

The virtual computer system comprises a plurality of virtual computers 3. That is, each of a host OS (operating system) 31, a driver OS 32 and a guest OS 33 is a virtual computer (or virtual CPU) 3. Each OS 31 to 33 acquires a control right (right of use) of one real CPU of the hardware 2 and is executed on the real CPU concerned, whereby each virtual computer 3 is implemented. The virtual computer monitor 1 is also likewise implemented.

The virtual computer monitor 1 controls the whole of the virtual computer system. The virtual computer monitor 1 performs dispatch of the respective OSs (that is, virtual computers) 31, 32, 33, simulation of a privilege instruction executed by each of the OSs 31, 32, 33, and control of the hardware 2 such as the real CPU, etc.

One host OS 31 is provided which operates as a virtual computer (domain) and manages the whole of the virtual computer system. The host OS 31 is started when the virtual computer system is booted, and controls the driver OS 32 and the guest OS 33 (the overall control includes starting, stopping, etc.). The host OS 31 is also operable as the driver OS 32 at the same time. The host OS 31 is equipped with a console 41 such as a display device or the like.

The driver OS 32 controls real (or physical) input/output devices (I/O devices) 42 and 43. The real I/O devices 42, 43 include many kinds of devices, for example, a magnetic disc device 42, a network 43, etc. The driver OS 32 may be provided with every many kinds of real I/O devices 42 and 43.The control of the real I/O devices 42 and 43 is executed by the driver OS 32. The driver OS 32 can also operate on both the host OS 31 and the guest OS 33. When the driver OS 32 operates on the guest OS 33, the guest OS 33 serves as an apparent driver OS 32.

The guest OS 33 does not have real I/O devices 42 and 43. The guest OS 33 may be regarded as a normal OS. For example, an application program may operate on a guest OS 33. The guest OS 33 requests the driver OS 32 to execute an I/O instruction, whereby the I/O instruction can be executed.

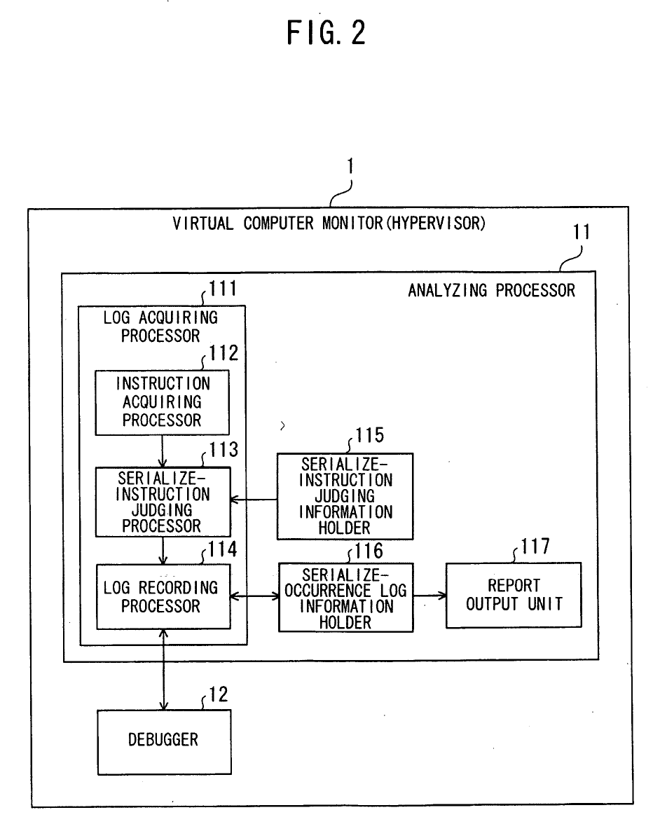

FIG. 2 is a diagram depicting an example of the construction of the virtual computer monitor 1 in the virtual computer system of FIG. 1.

The virtual computer monitor 1 is equipped with an analyzing processor 11 for acquiring log information of a pre-indicated instruction executed on the virtual computer system. In this example, the analyzing processor 11 acquires log information of a serialize-instruction. That is, in this example, the serialize-instruction is a pre-indicated instruction. The serialize-instruction is an instruction for initiating the serialization processing such as a memory compare & instruction or the like. The serialize-instruction induces the lock standby in many cases, and causes the performance deterioration of the virtual computer system.

The analyzing processor 11 acquires the log information of the serialize-instruction which causes the performance deterioration due to the lock standby. Therefore, as described later, the analyzing processor 11 uses allocation processing of the control right of the real CPU in the virtual computer system. This allocation processing is executed by the virtual computer monitor 1.

The analyzing processor 11 is implemented by CPU, a memory, a hard disc, etc. provided in the hardware 2 of the virtual computer system and a program, and is equipped with a log acquiring processor 111, a serialize-instruction judging information holder (hereinafter, judgment information holder) 115, a serialization occurrence log information holder (hereinafter referred to as log information holder) 116, and a report output unit 117.

The log acquiring processor 111 acquires the log information of the pre-indicated instruction executed in the virtual computer system. In this example, as described above, the log acquiring processor 111 acquires the log information of the serialize-instruction. Therefore, the log acquiring processor 111 has an instruction acquiring processor 112, a serialize-instruction judging processor (hereinafter referred to as a judgment processor) 113, and a log recording processor 114.

The return of the control right of the real CPU from the virtual computer 3 (31, 32, or 33) to the virtual computer monitor 1 is used as a trigger (hereinafter referred to as “control return timing”) for the instruction acquiring processor 112 to acquire an instruction at an instruction address (hereinafter referred to as “specific instruction address”) in a range determined based on the instruction address of the instruction which was last executed by the virtual computer 3 (that is, just before the control right concerned is returned). Therefore, the instruction acquiring processor 112 is informed of the return of the control right of the real CPU from the virtual computer 3 to the virtual computer monitor 1 by the virtual computer monitor 1.

The instruction of the specific instruction address comprises an instruction executed finally by the virtual computer 3 concerned (this instruction will be referred to as “reference instruction”) and instructions at instruction addresses of n before and after the reference instruction. In this example, n=10, and totally 21 instructions are acquired. The instruction acquiring processor 112 stores the acquired instructions into an acquiring memory (not shown), and sends notification of the storage to the judgment processor 113.

The virtual computer monitor 1 has a debugger 12 for debugging a program (e.g., an instruction sequence) executed on the virtual computer system. In this example, when the instruction acquired by the analyzing processor 11 is the indicated instruction described above, the debugger 12 acquires and records information concerning instruction calling of the acquired instruction.

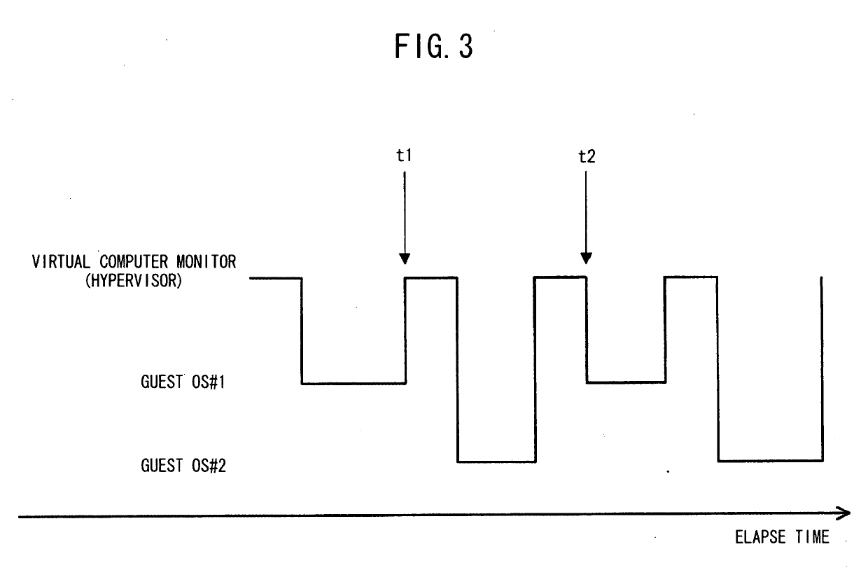

FIG. 3 is a diagram depicting the allocation of the control rights of the real CPUs in the virtual computer system.

The virtual computer monitor 1 and the virtual computer 3 operate on a plurality of physical (real) CPUs as described above. The virtual computer monitor 1 selectively allocates the right control of each real CPU to any one of the plurality of virtual computers 3 (serialization), thereby virtualizing the CPUs. Furthermore, the virtual computer monitor 1 takes back the control rights of the real CPUs allocated to the plurality of virtual computers 3 through specific processes.

That is, when the control right of a real CPU is allocated to the virtual computer 3, the virtual computer monitor 1 sets a dispatch timer every time the control right is allocated. Accordingly, even when the virtual computer 3 is using the real CPU, the control right is returned without fail to the virtual computer monitor 1 after a time set in the dispatch timer elapses. The virtual computer monitor 1 monitors whether the virtual computer 3, to which the control right is allocated, is set to an idling state or not. If the virtual computer 3 is under the idling state, the virtual computer monitor 1 forcedly takes back the control right from the virtual computer 3 concerned and allocates the control right concerned to another virtual computer 3.

Accordingly, after the virtual computer 3 to which the control right of a real CPU is allocated operates, the control right is returned without fail to the virtual computer monitor 1. The virtual computer monitor 1 saves the address of the last instruction executed by the virtual computer 3 from which the control right is returned (e.g., a final instruction) and the content of a register in preparation of the next operation of the virtual computer 3 concerned.

In FIG. 3, for simplification of the description, it is assumed that one real CPU is selectively distributed to two guest OS's 33. Here, the two guests OS's 33 are differentiated as guest OS #1 and guest OS #2.

For example, at a timing t1, the control right is returned from the guest OS #1 to the virtual computer monitor 1. At this time, the address of the instruction which was last executed by the guest OS #1 and the content of the register are saved in a backup memory (not shown). Subsequently, the control right concerned is allocated to the guest OS #1 at a timing t2. At this time, the address of the instruction and the content of the register which were saved are restored.

By returning the control right to the virtual computer monitor 1, the virtual computer monitor 1 can learn the last instruction executed by the virtual computer 3 (in this example, the guest OS #1 and #2) by referring to the saving memory. Therefore, for example, at the timing t1 at which the control right is returned from the guest OS #1 to the virtual computer monitor 1, the virtual computer monitor 1 refers to the saving memory to determine the address (instruction address) of the instruction executed by the guest OS #1 just before, and acquires the instructions of specific instruction addresses (for example, the 21 instructions) based on the instruction address concerned (in the guest OS #2, the same proceeding may be performed).

Upon reception of a notification of instruction acquisition, the judgment processor 113 refers to the acquiring memory and judges whether the acquired instruction is a pre-indicated instruction. The pre-indicated instruction is the serialize-instruction as described above. This judgment is executed according to the judgment information held in the judging information holder 115 (hereinafter referred to as “judgment information”).

The judging information holder 115 holds judgment information for indicating an instruction whose log information should be acquired. In this example, the judgment information indicates acquisition of the serialize-instruction as described above. The judgment information is preset in a serialize-instruction judgment table (hereinafter referred to as “judgment table” 130 provided in the judging information holder 115 prior to acquisition of the log information.

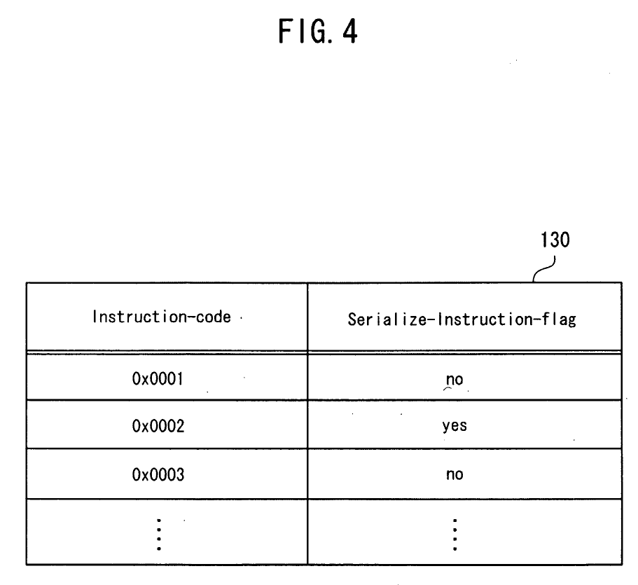

FIG. 4 depicts an example of the judgment table 130. The judgment table 130 is a representation of judgment information in a table style, and has a serialize-instruction judgment flag (Serialize-Instruction-flag, hereinafter referred to as “flag”) for every instruction code (Instruction-code).

The instruction code is an identification code for an instruction and is uniquely determined. The flag indicates whether the corresponding instruction is an instruction from which log information should be acquired (in this example, the serialize-instruction) or not. The flag for the serialize-instruction is set to “yes”, and the flags of instructions other than the serialize-instruction are set to “no”.

With respect to an instruction acquired by the instruction acquiring processor 112 (stored in the acquiring memory), the judgment processor 113 refers to the judgment table 130 by using the instruction code as a key, and checks whether the flag is “yes” or “no”. The judgment processor 113 judges an instruction of “yes” as a serialize-instruction.

When an acquired instruction is an indicated instruction, the log recording processor 114 records the log of the indicated command concerned. In this example, when the judgment processor 113 notifies the log recording processor 114 that the instruction concerned is a serialize-instruction, the log recording processor 114 acquires the log information of the instruction which is judged as a serialize-instruction in the acquired instructions, and records the log information concerned as serialize-occurrence log information into the log information holder 116.

The log information holder 116 holds the log information acquired by the log recording processor 114. In this example, the log information holder 116 holds the serialize-occurrence log information 140 which is the log information of the acquired serialize-instruction.

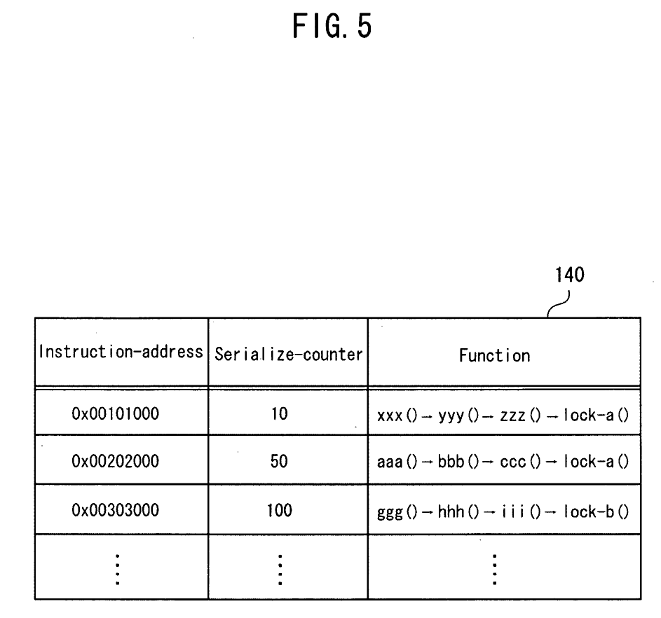

FIG. 5 is a diagram depicting an example of the serialize-occurrence log information 140. The serialize-occurrence log information 140 is represented in a table style, and has a serializing counter (Serialize-counter) and an operation function (Function) for every instruction address (Instruction-address).

The instruction address is the address of the acquired serialize-instruction, and is uniquely determined. The serializing counter is a value representing the frequency at which the serialize-instruction of the instruction address is acquired as log information.

The operation function is information concerning an instruction calling. In this example, as described above, the operation function is the information representing the calling relation of the acquired serialize-instruction. For example, the operation function depicted in FIG. 5 for the instruction address 0x00101000 indicates that the acquired serialize-instruction is an instruction lock-a( ), the instruction lock-a( ) is an instruction contained in a function zzz (or an instruction called by the function zzz), the function zzz is a function called by a function yyy( ), and the function yyy( ) is a function called by a function xxx( ). Accordingly, it may be understood that the serialize-instruction lock-a( ) is called through the function zzz and the function yyy( ) by the function xxx( ). That is, a calling route of the serialize-instruction concerned is learned.

The information concerning the instruction calling as described above can be obtained by the debugger 12 provided in the virtual computer monitor 1. As well known, the debugger 12 analyzes an executed program, that is, an instruction sequence for debugging. Accordingly, the debugger 12 tracks back the instruction address of the acquired instruction and the instruction address of the instruction calling this instruction concerned to obtain an instruction route reaching the acquired instruction concerned. When a processing target (acquired) instruction is a serialize-instruction, with respect to the serialize-instruction, the debugger 12 obtains the information concerning the calling of the serialize-instruction as described above, and transmits the information concerned to the analyzing processor 11 to record the information as serialize-occurrence log information 140 for the serialize-instruction concerned (the instruction address concerned) into the log information holder 116.

Furthermore, the log recording processor 114 refers to the serialize-occurrence log information 140 when acquiring the instruction address of the instruction which is judged as the serialize-instruction. When the acquired instruction address exists in the serialize-occurrence log information 140, the log recording processor 114 increments the value of the serialize-counter of the instruction address concerned in the serialize-occurrence log information 140 by +1. On the other hand, when the acquired instruction address does not exist in the serialize-occurrence log information 140, the log recording processor 114 stores the instruction address concerned into the serialize-occurrence log information 140, and increments the serialize-counter of the instruction address concerned by +1. Accordingly, when the instructions having the same instruction address are called through the same route, the log information of each instruction is not acquired, but only the frequency is recorded. Accordingly, the size of the serialize-occurrence log information 140 can be reduced.

Information concerning the calling of the instruction concerning the instruction address may be acquired by the debugger 12. The acquired information concerning the instruction calling may be recorded as the operation function of the instruction address concerned into the serialize-occurrence log information 140 by the debugger 12.

After the acquisition of the log information by the log acquiring processor 111 is completed, the report output unit 117 analyzes the log information, creates a report 150 of the log information and outputs log information. In this example, as described above, the report 150 is created based on the serialize-occurrence log information 140, and outputs the log information to an external device such as a display device, a print device, an external storage device or the like (not shown).

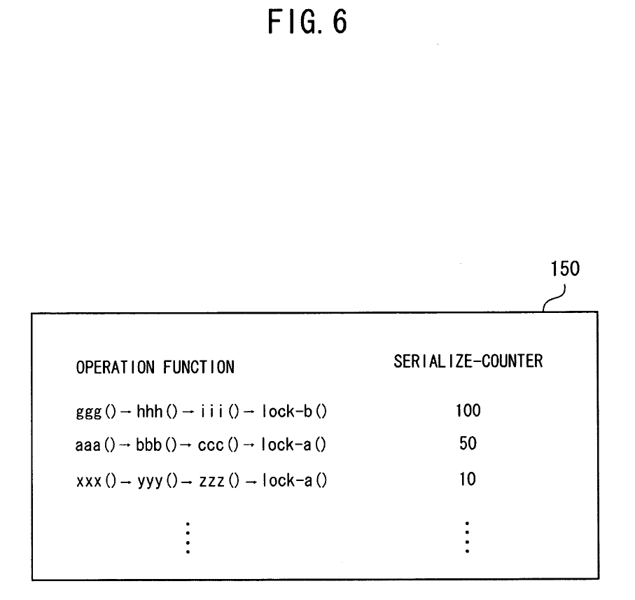

FIG. 6 is a diagram depicting an example of the report 150. The report 150 is created by arranging the log information in descending order of the value of the serialize-counter, for example on the basis of the serialize-occurrence log information 140.

For example, the following may be learned from the report 150. First, it is learned that there are many lock-b( ) serialize-instructions executed by the calling relation of “ggg( )→hhh( )→iii( )→lock-b( )”. Secondly, it is learned that there are two calling routes of “aaa( )→bbb( )→ccc( )→lock-a( )” and “xxx( )→yyy( )→zzz( )→lock-a( )” with respect to the serialize-instruction lock-a( ). Thirdly, it is learned that the acquiring frequency of the log information is larger in the calling relation of “aaa( )→bbb( )→ccc( )→lock-a( )”.

From the foregoing processing, the lock standby state can be understood, and the program correction which is more suitable for the status to enhance the performance of the virtual computer system can be performed. That is, with respect to the serialize-instruction lock-b( ), it is learned that the serialize-instruction lock-b( ) should be subjected to program correction and the effect thereof is larger. Furthermore, with respect to the serialize-instruction lock-a( ), it is learned that the execution based on the calling route of “aaa( )→bbb( )→ccc( )→lock-a( )” more frequently causes occurrence of the serialize-processing.

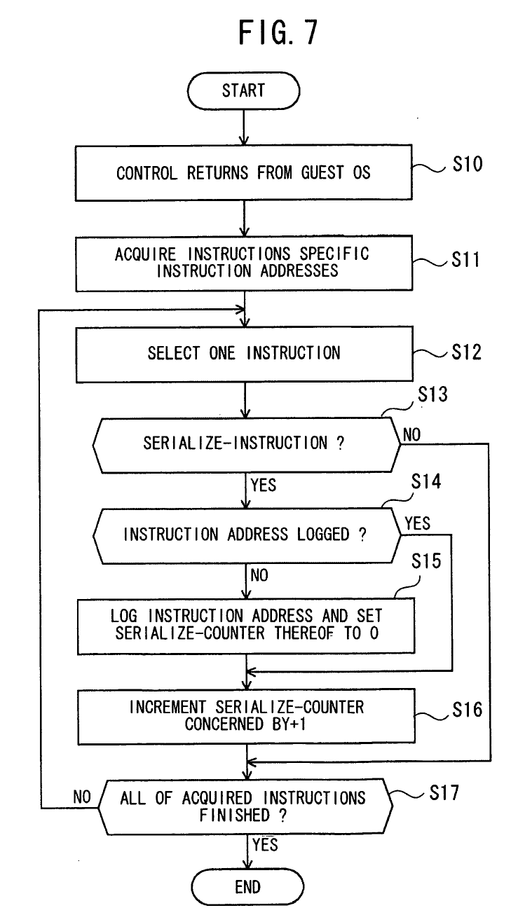

FIG. 7 is a log acquiring processing flow executed by the log acquiring processor 111. This processing flow is an example of the processing of using the return of the control right from the guest OS 33 to the virtual computer monitor 1 as a trigger, judging, based on the presence or absence of the serialize-instruction, whether the log acquiring processing is executed on the guest OS 33, and acquiring the log information if there is a serialize-instruction.

In the log acquiring processor 111, when the virtual computer monitor 1 notifies the instruction acquiring processor 112 that the control right has returned from the guest OS 33 to the virtual computer monitor 1 (step S10), the instruction acquiring processor 112 refers to the saving memory and determines the instruction address of the instruction which was last executed by the guest OS 33. Furthermore, based on the determined instruction address, the instruction acquiring processor 112 acquires instructions of specific instruction addresses (for example, 21 instructions) (step S11), and stores the instructions in the acquiring memory.

When the acquisition of the instructions of the specific instruction addresses concerned is notified by the instruction acquiring processor 112, one instruction is successively selected from the acquired instructions of the specific instruction addresses (the instructions stored in the acquiring memory), for example, in order from the head instruction address (step S12), whether the selected instruction concerned is a serialize-instruction or not is judged based on the judgment information of the judging table 130 (step S13).

When the instruction concerned is a serialize-instruction, upon notification of the judgment result by the judging processor 113, the log recording processor 114 judges whether the log information of the instruction address concerned has been acquired (e.g., the instruction address has been logged) or not (step S14). If logging has not yet been completed with respect to the instruction address concerned, the log recording processor 114 acquires the log information of the instruction address concerned, and sets the value of the serialize-counter of the instruction address concerned to 0 (initial value) (step S15). On the other hand, when the instruction address has been logged, the log recording processor 114 omits the step S15. Thereafter, the log recording processor 114 increments the serialize-counter thereof by +1 (step S16).

When the instruction concerned is not a serialize-instruction in step S13, the judgment processor 113 omits the processing of the steps S14 to S16 for the instruction concerned, and checks whether or not the processing of all the acquired instructions of the specific instruction addresses is finished (step S17). If the processing of all the acquired instructions has not yet been finished, the step S12 and the subsequent steps are repeated. If the processing of all the acquired instructions is finished, the processing is finished.

If the instruction address concerned has not yet been logged in step S14, information on instruction calling concerning the instruction of the instruction address concerned may be acquired and recorded as information of the operation function of the instruction address concerned into the serialize-occurrence log information by the debugger 12.

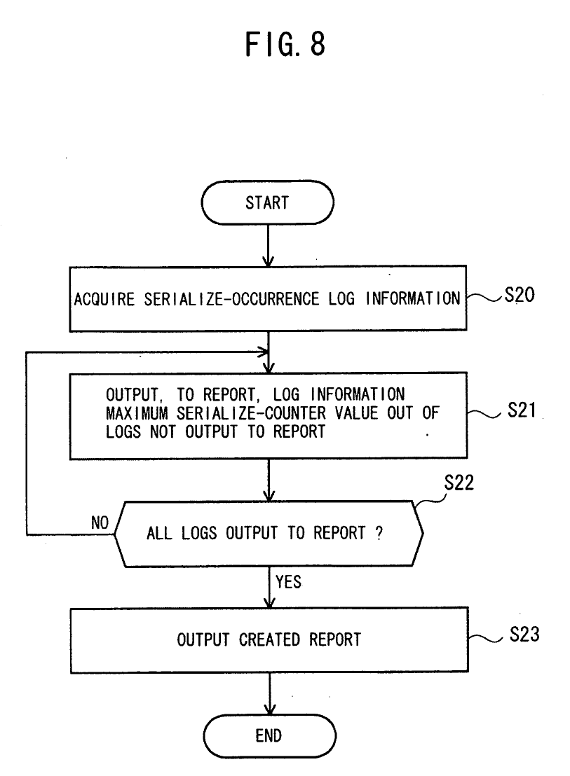

FIG. 8 is a report processing flow executed by the report output unit 117. This processing flow is an example of the processing of reporting based on the serialize-occurrence log information 140 which function becomes problematic. In this example, the report 150 of FIG. 6 is output.

The report output unit 117 acquires the serialize-occurrence log information 140 from the log information holder 116 (step S20), selects the log information having the maximum value of the serialize-counter from the log information which has not yet been output to the report 150, and outputs the operation function of the log information having the maximum value of the serialize-counter and the value of the serialize-counter to the report (step S21). Subsequently, the report output unit 117 checks whether all the log information in the serialize-occurrence log information 140 is output to the report 150 (step S22). If all the log information is not output, the step S21 and the subsequent steps are repeated. If all the log information is output, the created report 150 is output to an external device such as a display device, a print device, an external storage device, or the like (step S23).

The processing of the analyzing processor 11 described above can be implemented by a computer and a software program. The program may be recorded in a computer-readable recording medium, or supplied from a network.

The present invention is not limited to the above embodiment, and various modifications may be made without departing from the subject matter of the present invention.

For example, in the embodiment described above, when the control right of a real CPU is returned from the guest OS 33 to the virtual computer monitor 1, the log information is acquired by using the return of the control right as a trigger. However, the log information may be acquired by using, as a trigger, the return of the control right from a virtual computer 3 other than the guest OS 33 (that is, the host OS 31 and the driver OS 32) to the virtual computer monitor 1.

In the above-described embodiment, the log information of the serialize-instruction is acquired. However, the log information of an instruction other than the serialize-instruction may be acquired, the instruction concerned being executed in the virtual computer system. That is, in the judgment information stored in the judgment table 130, an instruction other than the serialize-instruction may be indicated as an instruction whose log information should be acquired. Accordingly with respect to an instruction other than the serialize-instruction, the log information thereof can be acquired. As a result, an instruction which induces processing requiring a long time and deteriorates the processing performance of the virtual computer system may be detected.

What is claimed is:

1. A recording medium having an instruction log acquiring program recorded therein, the program implementing a virtual computer monitor in a virtual computer system equipped with a plurality of real CPUs, a plurality of virtual computers each of which comprises a program operating on the plurality of real CPUs, and the virtual computer monitor for controlling the plurality of virtual computers, and making a computer as the virtual computer system execute:
holding, in a judgment information holder, judgment information indicating an instruction from which log information may be acquired;
acquiring instructions of instruction addresses in a range determined based on the instruction addresses of instructions which were last executed by the plurality of virtual computers when control rights of the plurality of real CPUs are returned from the plurality of virtual computers to the virtual computer monitor;
judging whether the acquired instruction is an instruction indicated by the held judgment information; and
recording, in a log information holder, log information containing the instruction address of an acquired instruction and a acquiring frequency at which the instruction concerned is acquired in the acquiring step when the acquired instruction is judged as the indicated instruction.

2. The recording medium according to claim 1, wherein the program makes the computer further execute analyzing the recorded log information to create a report, and outputting the created report.

3. The recording medium according to claim 1, wherein in the recording, when the acquired instruction is the indicated instruction, a debugger provided in the virtual computer system acquires information concerning instruction calling with respect to the acquired instruction concerned.

4. A virtual computer system having a plurality of real CPUs, a plurality of virtual computers each of which comprises a program operating on the plurality of real CPUs, and a virtual computer monitor for controlling the plurality of virtual computers, wherein the virtual computer monitor comprises:
a judgment information holder for holding judgment information which is information for indicating an instruction from which log information may be acquired;
a log information holder for recording the log information;
an instruction acquiring unit for acquiring instructions of instruction addresses in a range determined based on instruction addresses of instructions executed last by the plurality of virtual computers when a control right of the plurality of real CPUs is returned from the plurality of virtual computers to the virtual computer monitor;
an instruction judging unit for judging whether an instruction acquired by the instruction acquiring unit is an instruction indicated by the judgment information held in the judgment information holder; and
a log recording unit for recording, in a log information holder, log information containing the instruction address of an instruction acquired by the instruction judging unit and an acquiring frequency at which the instruction concerned is acquired in the acquiring step when the instruction acquired by the instruction judging unit is judged as the instruction indicated by the judgment information.
